(19) United States
(12) Patent Application Publication
(10) Pub. No.: US 2026/0336240 A1
(43) Pub. Date: Oct. 29, 2026

(54) METHOD FOR MANUFACTURING TIRES OF MULTIPLE DIMENSIONS

(71) Applicant: COMPAGNIE GENERALE DES ETABLISSEMENTS MICHELIN, Clermont-Ferrand (FR)

(72) Inventor: SYLVERE MAILLARD, Clermont-Ferrand (FR)

(21) Appl. No.: 19/117,883

(22) PCT Filed: Oct. 3, 2023
(86) PCT No.: PCT/FR2023/051525

§ 371 Date: Apr. 2, 2025

(30) Foreign Application Priority Data
Oct. 3, 2022 (FR) FR2210098

(51) Int. Cl. B29D 30/24; B29D 30/38

(52) U.S. Cl. CPC B29D 30/245; B29D 2030/381

(57) ABSTRACT

A method for manufacturing tires comprising manufacturing a first tire and manufacturing a second tire of different sizes, wherein the bead wires (8) are fitted with one and the same bead wire separation distance, and during the building step, when the radial expansion of the central portion of the carcass ply (4) reaches an intervention diameter strictly less than the formation diameter, a triangulation member (10) is placed in contact with the carcass ply (4) in order to modify the orientation of the carcass reinforcers (6) during a follow-up building period, the triangulation member (10) being provided with parallel reinforcers (12) forming a non-zero angle (B) with the circumferential direction and the initial direction of the reinforcers of the carcass ply, the intervention diameter and/or the triangulation member being different during the manufacture of the first tire and during the manufacture of the second tire.

### TECHNICAL FIELD

The invention belongs to the field of vehicle tyres, and relates more specifically to a method for manufacturing tyres of different sizes (different sidewall heights, and/or different axial widths) on the basis of one and the same initial bead wire separation distance.

### TECHNOLOGICAL BACKGROUND

By convention, consideration is given to a frame of reference (O, OX, OY, OZ), the centre O of which coincides with the centre of the tyre; the circumferential direction OX, axial direction OY and radial direction OZ refer to a direction tangential to the tread surface of the tyre in the direction of rotation, to a direction parallel to the axis of rotation of the tyre, and to a direction orthogonal to the axis of rotation of the tyre, respectively.

Radially inner and radially outer mean closer to and further away from the axis of rotation of the tyre, respectively. Axially inner and axially outer mean closer to and further away from the equatorial plane of the tyre, respectively, the equatorial plane of the tyre being the plane that passes through the middle of the tread of the tyre and is perpendicular to the axis of rotation of the tyre.

The makeup of the tyre is usually described by a representation of its constituent components in a meridian plane, which means to say a plane containing the axis of rotation of the tyre. Such a choice is motivated by the axisymmetry of the geometry of the tyre about its axis of rotation. The tyre also comprises a plane of symmetry which is orthogonal to the axis of rotation and passes through the centre of the tread: this is the equatorial plane.

It is commonplace to divide the tyre into three distinct zones comprising a crown, which is intended to come into contact with the ground via a tread, a heel zone, which ensures the mechanical connection of the tyre on the rim on which it is intended to be mounted, and a sidewall zone, which is intended to form the junction between the two axial ends of the crown and the beads of the heel zone.

A radial tyre has a crown reinforcement, radially on the inside of the tread, and a carcass reinforcement, radially on the inside of the crown reinforcement. The crown reinforcement of a radial tyre comprises a superposition of crown layers extending circumferentially, radially on the outside of the carcass reinforcement. Each crown layer is made up of reinforcers that are parallel to one another and coated in a polymer material of the elastomer or elastomer compound type.

The carcass ply comprises a main part which joins the two beads together and is wrapped, in each bead, around an annular reinforcing structure, also referred to as bead wire. The carcass ply comprises reinforcers in an elastomer compound.

Elastomer compound is given to mean an elastomer material obtained by blending its various constituents. An elastomer compound conventionally comprises an elastomer matrix with at least one diene elastomer of the natural or synthetic rubber type, at least one reinforcing filler of the carbon black type and/or of the silica type, a crosslinking system that is usually sulphur-based, and protective agents. For some applications, the elastomers in question can also comprise thermoplastics (TPE).

Numerous developments have been made for modifying the angle of the carcass reinforcement ply in the crown zone in order to give it properties that allow it to contribute to forming the crown reinforcement, in interaction with another ply made up of reinforcing elements which would have an angle of orientation with respect to the circumferential direction that is of the opposite sign to that formed by the carcass reinforcement elements in the zone underneath the crown. In the crown reinforcement zone, the angles formed by the threads of the carcass reinforcement ply and by the crown reinforcement ply with respect to the circumferential direction generally range between 15° and 40°.

By way of example, this type of tyre is described in the patent FR 1 413 102. This tyre comprises a carcass reinforcement made up of threads which are disposed radially or substantially radially in the heel zone and in the sidewall zone and have an orientation substantially deviating from the radial orientation over a portion of the zone where the crown reinforcement extends.

In support of these developments, numerous embodiments have been proposed. These methods make use of the properties provided by the triangulation effects when two plies, which were superposed on one another beforehand and adhere to one another, have different, opposite angles with respect to a circumferential direction and are stretched in this same direction. This effect manifests itself in the reduction of the orientation of the angles of these plies with respect to the circumferential direction. This “triangulation” mechanism is described in full in the publication FR 2 797 213.

To produce this triangulation, it is necessary, as set out in the patents FR 1 413 102 and EP1623819 A1, firstly to lay one after another, on a substantially cylindrical tyre manufacturing drum, one or more carcass reinforcement plies of which the threads are oriented radially, and then to lay a crown reinforcement ply having threads oriented obliquely with respect to the carcass threads, and to make these various plies adhere to one another so as to form what is conventionally referred to as a carcass. Then, secondly, the carcass is built on a tyre building drum comprising a membrane, so as to form a substantially toroidal green tyre.

During the building phase, during which a cylindrical green tyre is transformed into a toroidal green tyre, the increase in the diameter of the central part intended to make up the crown zone amounts to stretching the crown reinforcement ply and the carcass reinforcement ply in the longitudinal direction or in the circumferential direction, and to giving angles of smaller absolute value to the carcass reinforcement threads in this crown zone and the threads of the crown reinforcement ply.

The tyres can have a variety of sizes, for example different sidewall heights, and/or different axial widths. In order to obtain this variety of sizes, nowadays it is necessary to have available carcass plies of various axial widths, which involves holding large stocks of carcass plies and makes it more complex to supply workstations since the carcass plies provided and mounted on the drum must correspond to those required for the desired dimensions of the tyre. Moreover, when being mounted on the drum, it must be precisely adjusted with a value for the bead wire separation distance (the axial distance between the bead wires) that is specific to each tyre size. As a result, a change of dimension in the tyre to be manufactured generally involves modifying the adjustments made to the drum of the machine, and this is a very lengthy operation that involves stoppage of the machine, thereby reducing the productive time.

### SUMMARY OF THE INVENTION

The invention therefore aims to as far as possible limit the occurrence of operations of changing the adjustments made to the machine in order to improve productivity and simplify constraints on storing and providing the carcass plies, while still maintaining a capacity to produce a very wide variety of tyre sizes.

To that end, the invention provides a method for manufacturing tyres comprising manufacturing a first tyre and manufacturing a second tyre, the first tyre and the second tyre having different sizes, the manufacture of the first tyre and the manufacture of the second tyre comprising the following steps:
laying a carcass ply on a cylindrical drum at an initial diameter, said carcass ply comprising carcass reinforcers extending between two axial end portions of the carcass ply surrounding a central portion of the carcass ply,
fitting bead wires at each of the axial end portions of the carcass ply, the bead wires defining a bead wire separation distance between them,
a step of building the tyre by causing a radial expansion of the central portion of the carcass ply until said carcass ply reaches a formation diameter,
a step of forming the tyre, comprising laying, on a radially outer face of the carcass ply, at least one crown ply provided with parallel reinforcers forming a non-zero angle with the circumferential direction and the direction of the reinforcers of the carcass ply, and laying a tread,
   wherein, during the manufacture of the first tyre and the manufacture of the second tyre, the bead wires are fitted with one and the same bead wire separation distance, and during the building step, when the radial expansion of the central portion of the carcass ply reaches an intervention diameter strictly less than the formation diameter, a triangulation member is placed in contact with the carcass ply in order to modify the orientation of the carcass reinforcers during a follow-up building period, said triangulation member being provided with parallel reinforcers forming a non-zero angle with the circumferential direction and the initial direction of the reinforcers of the carcass ply, the intervention diameter and/or the triangulation member being different during the manufacture of the first tyre and during the manufacture of the second tyre.

Laying the triangulation member at the intervention diameter makes it possible, without modifying the adjustment of the bead wire separation distance, to modify the axial length of the carcass ply and therefore to manufacture tyres of various sizes, and in particular makes it possible to use a carcass ply of the same initial axial width, connecting the bead wires, to obtain tyres of different sizes. This results in a simplification of the logistics and manufacture of tyres of various sizes.

The invention is advantageously supplemented by the following various features considered alone or in the various possible combinations thereof:
the intervention diameter is at least 10 mm less, preferentially at least 20 mm less than the formation diameter;
the triangulation member has an axial width less than 80% of the final width of the tyre;
the parallel reinforcers of a triangulation member form, prior to and while being placed in contact with the carcass ply, an angle of between 65° and 80° with the carcass reinforcers;
the triangulation member is a fabric impregnated with an elastomer compound;
the triangulation member is placed in contact with the carcass ply on an outer surface of the carcass ply;
the manufacture of the first tyre makes use of a first triangulation member provided with parallel reinforcers forming a first non-zero angle with the circumferential direction and the initial direction of the carcass reinforcers, and the manufacture of the second tyre makes use of a second triangulation member provided with parallel reinforcers forming a second non-zero angle with the circumferential direction and the initial direction of the reinforcers of the carcass ply, the second angle differing from the first angle by at least 5°;
the manufacture of the first tyre makes use of a first triangulation member having a first axial width, and the manufacture of the second tyre makes use of a second triangulation member having a second axial width, the second axial width differing from the first axial width by at least 10 mm;
during the manufacture of the first tyre, a triangulation member is placed in contact with the carcass ply of said first tyre at a first intervention diameter, and during the manufacture of the second tyre, a triangulation member is placed in contact with the carcass ply of said second tyre at a second intervention diameter, the second intervention diameter differing from the first intervention diameter by at least 10 mm.

The invention also relates to a tyre comprising the following in radial sequence: an inner liner, a carcass ply, a crown ply, a tread, the tyre also comprising a triangulation member in contact with the carcass ply and disposed radially underneath the crown ply, the triangulation member having an axial width less than 80% the final width of the tyre. The tyre may have all the characteristics of a tyre manufactured by the method of the invention, and is preferably manufactured by the method of the invention. The invention can relate to a first tyre and a second tyre as specified, having different sizes but comprising one and the same carcass ply with a different axial length on account of the use of the triangulation member.

### PRESENTATION OF THE FIGURES

Further features, objects and advantages of the invention will become apparent from the following description, which is purely illustrative and non-limiting and which should be read in conjunction with the appended drawings, in which:

FIG. 1 shows an exemplary view, in partial section, of the fitting of an annular bead wire at a width end portion of the carcass ply of a tyre while this portion is being manufactured, according to one possible embodiment of the invention,

FIG. 2 shows an exemplary view, in partial section, of the carcass ply during a first part of the building step, before the contacting of the triangulation member,

FIG. 3 shows an exemplary view, in partial section, of the carcass ply during the contacting of the triangulation member,

FIG. 4 shows a schematic top view of the spatial organization of the respective reinforcers of the carcass ply and of the triangulation member, before the second part of the building step,

FIG. 5 shows a schematic top view of the spatial organization of the respective reinforcers of the carcass ply and of the triangulation member, during the second part of the building step,

FIG. 6 shows an exemplary view, in partial section, of the carcass ply during a second part of the building step, after the contacting of the triangulation member,

FIG. 7 shows an exemplary view, in partial section, of a tyre while it is being manufactured, while at least one crown ply is being laid during a forming step which comes after the building step,

FIG. 8 shows an exemplary view, in partial section, of a tyre while it is being manufactured, after the tread has been fitted,

FIG. 9 is a graph showing exemplary distances between the intervention diameter and the formation diameter as a function of the reduction in the bead wire separation distance to obtain a 245/45 R18 tyre, according to the type of triangulation member used,

FIG. 10 is a graph showing exemplary distances between the intervention diameter and the formation diameter as a function of the reduction in the bead wire separation distance to obtain a 235/55 R19 tyre, according to the type of triangulation member used.

### DETAILED DESCRIPTION

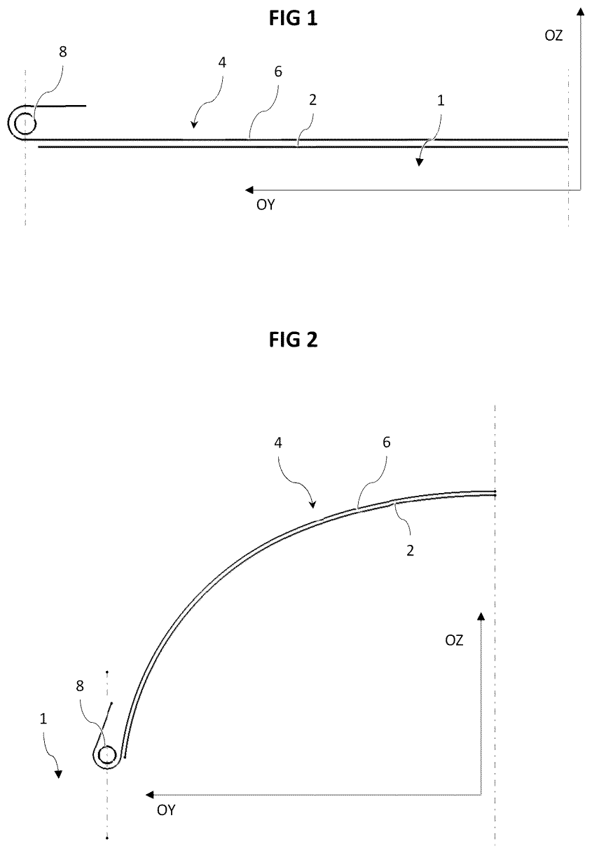

The method according to the invention makes it possible to manufacture a first tyre and to manufacture a second tyre, the first tyre and the second tyre having different sizes, although during the manufacture of the first tyre and the manufacture of the second tyre the annular bead wires are fitted with one and the same initial bead wire separation distance. In order to describe the method that enables such a result, a method for manufacturing a tyre will now be described with reference to FIGS. 1, 2, 3, 4, 7 and 8. It should be noted that, for the sake of simplicity, these figures show only one portion of the tyre or its components in a meridian plane, on account of the symmetry of the tyre.

The method for manufacturing tyres is a “flat” method, in which steps of laying elements on a cylindrical drum 1 with a central axis are performed first. The diameter of the cylindrical drum is configured to change during a subsequent building step. Before this building step, the cylindrical drum 1 has an initial diameter.

To obtain the flat configuration illustrated in FIG. 1, an inner liner layer 2, for example on the basis of butyl rubber, is generally firstly laid on the cylindrical drum 1. Then, a carcass ply 4 is laid on the cylindrical drum 1 at this initial diameter, typically on the inner liner 2. The carcass ply 4 comprises carcass reinforcers 6 extending between two axial end portions of the carcass ply 4 surrounding a central portion of the carcass ply 4. The carcass ply 4 is typically a fabric impregnated with an elastomer compound. It should be noted that, for the sake of simplicity and clarity, only the carcass reinforcers 6 are illustrated in most of the figures.

The axial width is understood to be the distance measured in a straight line along the axis of rotation of the cylindrical drum 1 (axis OY), or of the tyre. The axial length, or LA, is understood to be the curvilinear length from bead wire 8 to bead wire 8 on the tyre along the carcass ply 4, in a meridian plane in the axial direction OY and radial direction OZ. The bead wire separation distance, or ET, is understood to be the distance from bead wire 8 to bead wire 8 in a straight line in the axial direction OY in a meridian plane (OY, OZ). Thus, the initial axial length is equal to the initial axial width and to the bead wire separation distance in a flat method.

FIG. 4 shows how these carcass reinforcers 6 are initially organized. A plurality of parallel carcass reinforcers 6 are evenly distributed around the circumference of the cylindrical drum 1. Typically, when the carcass reinforcers 6 are being laid, they extend axially, i.e. with a direction parallel to the central axis of the cylindrical drum 1 which is intended to correspond to the axis of rotation of the tyre, perpendicularly to a direction tangent to the tread surface of the tyre in the direction of rotation. The angle α formed by the carcass reinforcers 6 with the circumferential direction generally ranges between 80° and 100°, and preferably between 85 and 95°, and for example is 90°, like in the example in FIG. 4.

With preference, the carcass reinforcers 6 are textile cords, each cord being obtained by twisting a twist T2 of N strands of a textile material in a first given direction (respectively in the S or Z direction), with N≥1, each strand resulting from overtwisting a twist T1 of a spun yarn of said textile material in a second direction opposite to the first direction. With preference, the spun yarns are made of a hybrid assembly of filaments of textile materials (such as nylon, PET, aramid). Advantageously, the number N of strands for the twisting ranges between 2 and 6, and preferentially N=2. Preferentially the overtwisting twist T1 and the twisting twist T2 are identical, and less than 500 turns per metre, preferentially T1 and T2 are identical and less than 440 turns per metre, and more preferentially still T1 and T2 are identical and less than or equal to 315 turns per metre. The carcass reinforcers have a strength of between 130 and 340 daN/cm.

Annular bead wires 8 are then fitted at each of the axial end portions of the carcass ply 4, the annular bead wires 8 defining a bead wire separation distance ET between them. The bead wire separation distance ET is the length measured from bead wire 8 to bead wire 8 along the carcass ply 4, in the axial direction Oy. The carcass ply 4 is then a textile or metal reinforcer connecting the two bead wires 8. In detail, and conventionally, a bead is formed by turning up the axial end portions of the carcass ply 4, thus enclosing each bead wire 8.

Obtaining the flat configuration illustrated in FIG. 1 is followed by a step of building the tyre, during which the central portion of the carcass ply 4 is made to radially expand until said carcass ply 4 reaches a formation diameter, which is the diameter at which the crown plies are laid. For example, the carcass can be transferred to another cylindrical drum 1, and air can be injected into the carcass in order to inflate it, thus causing a radial expansion of the carcass ply 4. It is also possible to keep the carcass on the same cylindrical drum 1. Other methods can be employed to make the central portion of the carcass ply 4 radially expand. For the sake of clarity and simplicity, the cylindrical drum 1 is not shown during its radial expansion, since it only presses the carcass ply 4 outwards via the inner liner 2.

Within the context of the invention, this building step is divided into two parts: a first part and a second part.

The first part of the building step is similar to the building in the prior-art methods. However, when the radial expansion of the central portion of the carcass ply 4 reaches an intervention diameter strictly less than the formation diameter, a triangulation member 10 is placed in contact with the carcass ply 4 in order to modify the orientation of the carcass plies 6 during a follow-up building period. The triangulation member 10 can be defined as a triangulation ply. With preference, for ease of implementation reasons, the radial expansion of the central portion of the carcass ply 4 can be temporarily stopped in order to enable the contacting of the triangulation member 10, but it is possible to not stop the radial expansion of the central portion of the carcass ply 4.

This triangulation member 10 is provided with parallel triangulation reinforcers 12 forming a non-zero angle with the circumferential direction and the initial direction of the reinforcers 6 of the carcass ply 4, as illustrated in FIG. 4. The angle β formed by the triangulation reinforcers and the circumferential direction OX typically ranges between 10° and 30°, and preferably between 15° and 20°, i.e. an angle with the carcass reinforcers ranges between 50° and 90°, and preferably between 65° and 80°.

The triangulation member 10 has, when it is laid, an axial width, i.e. a width in the direction of the bead wire separation distance ET and thus of the drum axis 1 (axis OY), of between 30% and 80% of the final width of the tyre. More specifically, the axial width of the triangulation member 10 may range between 80 mm and 160 mm, and preferably between 100 mm and 150 mm. For example, an axial width of the triangulation member of 100 mm can represent between 30% and 50% of the final width of the tyre, whereas an axial width of the triangulation member 10 of 150 mm may represent between 50% and 80% of the final width of the tyre. More generally, the triangulation member 10 preferably has an axial width less than 80% of the final width of the tyre. The final width of the tyre is understood to be the width in the standardized designation of the dimensions of the tyre. It will be recalled that the axial width of the triangulation member 10 is the distance in a straight line in the axial direction OY of the triangulation member 10, in a cross section of the tyre.

Advantageously, the triangulation member 10 may have features similar to those of the carcass ply 4, in particular in terms of composition or manufacture, except in terms of initial axial width, which for the triangulation member 10 is less than the initial bead wire separation distance. For example, the triangulation reinforcers 12 may be manufactured in the same way as the carcass reinforcers 6, although with different angular orientations. Typically, the triangulation member 10 is a fabric impregnated with an elastomer compound. It is possible, however, for certain characteristics of the triangulation member 10 to differ from those of the carcass ply 4, since their functions are quite different.

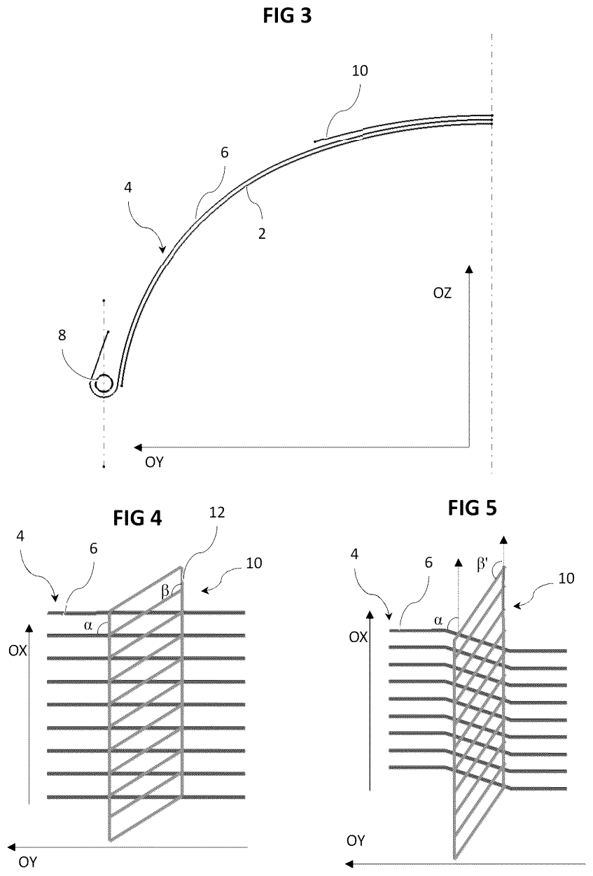

Typically, the triangulation member 10 is placed in contact with the carcass ply 4 on a radially outer surface of the carcass ply, as illustrated in FIG. 3. In other words, the triangulation member 10 is added to the outside of the carcass ply 4.

The radial expansion of the central portion of the carcass ply 4 is continued during a second part of the building step. The contact between the triangulation member 10 and the carcass ply 4 causes the orientation of the carcass reinforcers 6 to be modified at least in the contact zone, as illustrated in FIG. 5. More specifically, in the contact zone, the angle α′ formed by the carcass reinforcers 6 with the circumferential direction OX is modified in an opposite direction to the initial angle β formed by the triangulation reinforcers 12 and the circumferential direction OX. This angle β formed by the triangulation reinforcers 12 and the circumferential direction OX is also altered to an angle β′ during the second part of the building step. On account of the modification of the orientation of the carcass reinforcers 6, which, in the zone of contact with the triangulation member 10, move away from an orientation close to the axial direction (angle α between 8° and 100°, and preferably between 85° and 95° with respect to the circumferential direction OX), while still keeping the same physical extent, the result is a reduction in the axial length of the carcass ply 4. The modification of the angle β also causes a reduction in the axial width of the triangulation member 10. As a result, the triangulation member 10, after building and in particular in the finished tyre, still has a final axial width less than 80% of the final width of the tyre. With preference, the triangulation member 10, after building and in particular in the finished tyre, has a final axial width less than 80% of the axial width of each crown ply NST1, NST2.

FIG. 5 schematically shows how the angular orientations of the carcass reinforcers 6 and the triangulation reinforcers 12 are modified. The deflection undergone by these reinforcers 6, 12 essentially depends on the following parameters:
the increase in the diameter during the second part of the radial expansion, which depends on the relationship between the intervention diameter and the formation diameter,
the respective initial angular orientations of the carcass reinforcers 6 (angle α) and of the triangulation reinforcers 12 (angle β),
the axial width of the contact zone, and thus the axial width of the triangulation member 10.

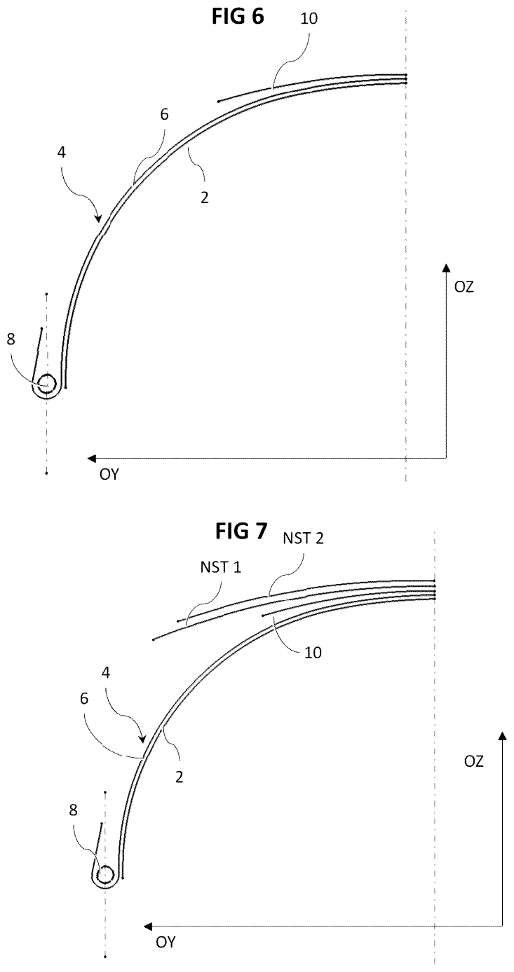

The radial expansion of the central portion of the carcass ply 4 is continued during the second part of the building step until the carcass ply 4 reaches a formation diameter, as illustrated in FIG. 6. It is at this formation diameter that the crown plies and the tread are added.

Since it is during the second part of the building step that the triangulation member 10 is involved, it is preferable, to obtain a significant effect, if this second part encompasses a non-negligible radial expansion of the carcass ply 4: the more the radial expansion affects the triangulation member 10, the more the orientation of the carcass reinforcers 6 can be modified, and the more it is possible to reduce the axial length of the carcass ply 4. As a result, the intervention diameter is preferably at least 10 mm less, and preferentially at least 20 mm less than the formation diameter.

The manufacture of the tyre is then continued by a step of forming the tyre, comprising laying, on a radially outer face of the carcass ply 4, at least one crown ply NST1, NST2 provided with parallel reinforcers forming a non-zero angle with the circumferential direction OX and the direction of the carcass reinforcers 6. The crown plies NST1, NST2 are laid such that their respective reinforcers intersect with one another and with the reinforcers of the carcass ply 4, in order to use superposition to form triangular, and thus non-deformable, cells which ensure good road holding of the tyre. The laying of the crown plies NST1, NST2 and the characteristics thereof are conventional and known to a person skilled in the art, and will not be described in more detail. However, it should be noted preferably that the diameter of the cylindrical drum 1 no longer increases once the formation diameter is reached, since it is not necessary for the crown plies NST1, NST2 to act on the carcass reinforcers 6. In the example illustrated, the triangulation member 10 is in the tyre after manufacture, between the carcass ply 4 and the first crown ply NST1.

Finally, the forming step ends by laying a tread at the crown of the tyre, possibly with the laying of a hooping belt before the tread is laid. Advantageously, the laying of at least one crown ply NST1, NST2 is obtained by holding said crown ply NST1, NST2 and the tread in place until the carcass reaches them as it radially expands.

The subsequent steps for manufacturing the tyre, such as curing or vulcanizing, then follow. Since these forming steps and subsequent steps are conventional and known to a person skilled in the art, they will not be described in more detail.

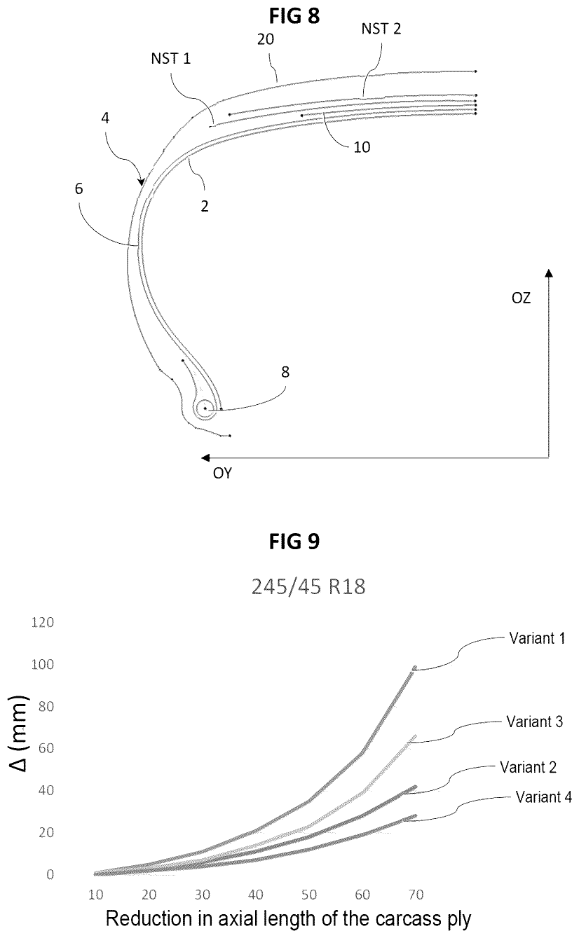

FIG. 8 shows an exemplary tyre obtained by the present method, this time showing the elastomer compound. It should be noted that the triangulation member 10 is present in the final tyre, which comprises the following in radial sequence: an inner liner 2, a carcass ply 4, a crown ply NST1, NST2, a tread 20, the tyre also comprising a triangulation member 10 in contact with the carcass ply and disposed radially underneath the crown ply NST1, NST2, the triangulation member 10 having a final axial width less than 80% the final width of the tyre.

As mentioned in relation to FIG. 5, several parameters make it possible to obtain tyres of different sizes on the basis of one and the same initial bead wire separation distance, thereby making it possible in particular to use one and the same carcass ply 4 (same initial axial width) to obtain tyres of different sizes (with different axial lengths of the carcass ply 4). In particular, on account of the modification of the angular orientations of the carcass reinforcers 6, the result is a reduction in the axial length of the carcass ply 4, and this ultimately achieves a modification of the width of the tyre. The same applies for the width of the contact zone, and thus the axial width of the triangulation member 10. As a result, with one and the same initial bead wire separation distance, it is possible to obtain different tyre widths.

FIG. 9 shows examples of the difference A between the intervention diameter and the formation diameter as a function of the reduction in the axial length of the carcass ply 4 to obtain a 245/45 R18 tyre, according to different variants of triangulation member 10. Table 1 shows the characteristics of the four variants of the triangulation member 10 for this example:

TABLE 1

| | Variant | Variant | Variant | Variant |
|---|---|---|---|---|
| | 1 | 2 | 3 | 4 |
| α in degrees | 90 | 90 | 90 | 90 |
| β in degrees | 15 | 20 | 15 | 15 |
| Axial width of the | 150 | 150 | 100 | 150 |
| triangulation member in mm | | | | |
| Minimum intervention | 486 | 486 | 486 | 486 |
| diameter in mm | | | | |
| Formation diameter in mm | 686 | 686 | 686 | 686 |
| Amplitude of Δ in mm | [0; 153] | [0; 153] | [0; 153] | [0; 153] |

where a is the angle formed by the carcass reinforcers 6 with the circumferential direction OX, B is the angle formed by the triangulation reinforcers 12 and the circumferential direction OX, and A is the difference between the intervention diameter and the formation diameter. The minimum intervention diameter corresponds to the initial diameter at which the carcass ply 4 is laid, which is that of the rim, i.e. 486 mm for a rim size of 18 inches (R18).

FIG. 9 can be regarded as a chart indicating the ways of applying a triangulation member 10 in order to obtain a 245/45 R18 tyre on the basis of different initial bead wire separation distances. For example, when using a triangulation member 10 according to variant 3, and seeking a reduction in the axial length of the carcass ply 4 of about 65 mm relative to the initial bead wire separation distance, the triangulation member 10 should be placed in contact with the carcass ply at an intervention diameter 60 mm less than the formation diameter.

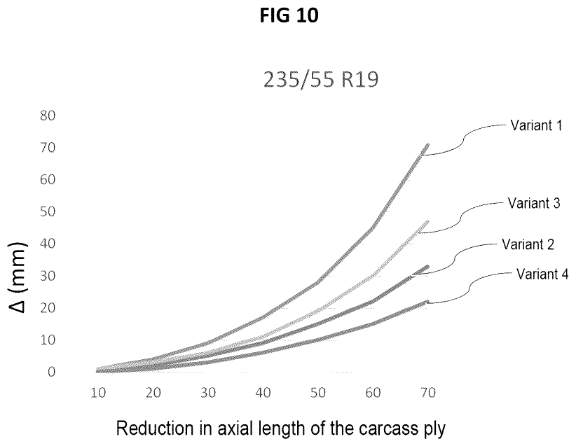

FIG. 10 shows examples of the difference A between the intervention diameter and the formation diameter as a function of the reduction in the bead wire separation distance to obtain a 235/55 R19 tyre, according to different variants of triangulation member. Table 2 shows the characteristics of the four variants of the triangulation member 10:

TABLE 2

| | Variant | Variant | Variant | Variant |
|---|---|---|---|---|
| | 1 | 2 | 3 | 4 |
| α in degrees | 90 | 90 | 90 | 90 |
| β in degrees | 15 | 20 | 15 | 15 |
| Axial width of the | 150 | 150 | 100 | 150 |
| triangulation member in mm | | | | |
| Minimum intervention | 510 | 510 | 510 | 510 |
| diameter in mm | | | | |
| Formation diameter in mm | 692 | 692 | 692 | 692 |
| Amplitude of Δ in mm | [0; 182] | [0; 182] | [0; 182] | [0; 182] |

where α is the angle formed by the carcass reinforcers 6 with the circumferential direction, β is the angle formed by the triangulation reinforcers 10 and the circumferential direction, and A is the difference between the intervention diameter and the formation diameter. The minimum intervention diameter corresponds to the initial diameter at which the carcass ply 4 is laid, which is that of the rim, i.e. 510 mm for a rim size of 19 inches (R19). Like FIG. 9, FIG. 10 can be regarded as a chart indicating the ways of applying a triangulation member 10 in order to obtain a 235/55 R19 tyre on the basis of different initial bead wire separation distances. For example, when using a triangulation member 10 according to variant 3, and seeking a reduction in the axial length of the carcass ply 4 of about 65 mm relative to the initial bead wire separation distance, the triangulation member 10 should be placed in contact with the carcass ply 4 at an intervention diameter 40 mm less than the formation diameter.

These examples show that using the triangulation member 10 makes it possible to obtain very different tyre sizes on the basis of one and the same initial bead wire separation distance. It is possible to easily obtain reductions in the axial (curvilinear) length of the carcass ply 4 up to 70 mm, or even more depending on the characteristics of the tyre and of the triangulation member 10. It is thus possible to continue to use one and the same carcass ply 4, with one and the same initial axial width corresponding to the bead wire separation distance, since the method makes it possible to obtain different axial lengths for the carcass ply 4 at the end of the building.

Thus, after having manufactured a series of first tyres having first sizes, and in particular a first curvilinear axial length of the carcass ply 4, it is possible, without modifying the initial bead wire separation distance, to manufacture a series of second tyres having second sizes different from the first sizes, and in particular a second curvilinear axial length of the carcass ply 4 which is different from the first curvilinear axial length of the carcass ply 4 in the final tyre. All that is needed is to vary the intervention diameter and/or the triangulation member 10 between the manufacture of the first tyres and the manufacture of the second tyres. It is then possible to use one and the same carcass ply 4 with one and the same axial width for the first tyres and the second tyres. This is because the initial axial width of the carcass ply 4 is dictated by the bead wire separation distance ET, which stays the same.

Thus, by using triangulation members 10 which are identical or different, but are at different intervention diameters, the second part of the building will have a different duration, and different effects on the carcass ply 4. For example, during the manufacture of the first tyre, a triangulation member 10 is placed in contact with the carcass ply of said first tyre at a first intervention diameter, and during the manufacture of the second tyre, a triangulation member 10 (identical to or different from that used for the first tyre) is placed in contact with the carcass ply 4 of said second tyre at a second intervention diameter, the second intervention diameter being different from the first intervention diameter. With preference, the second intervention diameter differs from the first intervention diameter by at least 10 mm.

The two triangulation members 10 may be different, and may in particular differ by the angle β formed by the triangulation reinforcers 12 with the circumferential direction. In particular, when the manufacture of the first tyre makes use of a first triangulation member 10 provided with parallel reinforcers 12 forming a first non-zero angle with the circumferential direction and the initial direction of the carcass reinforcers 6, and when the manufacture of the second tyre makes use of a second triangulation member 10 provided with parallel reinforcers 12 forming a second non-zero angle with the circumferential direction and the initial direction of the carcass reinforcers 6, the second angle preferably differs from the first angle by at least 5°.

Two triangulation members 10 may also differ by their respective axial widths. For example, the manufacture of the first tyre can make use of a first triangulation member 10 having a first axial width, and the manufacture of the second tyre can make use of a second triangulation member 10 having a second axial width, the second axial width differing from (being larger or smaller than) the first axial width by at least 10 mm.

The result of this is that it is possible to obtain a first tyre and a second tyre as specified, having different sizes but comprising one and the same carcass ply 4 (same initial axial width corresponding to the same bead wire separation distance ET) with a different axial length between the two tyres on account of the use of the triangulation member 10.

Using all these possibilities makes it possible to manufacture an entire range of tyres on the basis of the same bead wire separation distance, and thus without changing numerous adjustments made to the cylindrical drums 1 or even without changing certain components, such as the carcass ply 4 which can stay the same. Moreover, the result of this is that the logistics are a lot simpler, since it is no longer necessary to provide a different supply and storage for each tyre size.

The invention is not limited to the embodiment described and shown in the appended figures. Modifications are still possible, in particular as regards the makeup of various technical features or by substitution of equivalent techniques, without otherwise departing from the scope of protection of the invention.

1.-9. (canceled)

10. A method for manufacturing tires comprising manufacturing a first tire and manufacturing a second tire, the first tire and the second tire having different sizes, the manufacture of the first tire and the manufacture of the second tire comprising the following steps:
laying a carcass ply on a cylindrical drum at an initial diameter, the carcass ply comprising carcass reinforcers extending between two axial end portions of the carcass ply surrounding a central portion of the carcass ply;
laying bead wires at each of the two axial end portions of the carcass ply, the bead wires defining a bead wire separation distance between the bead wires;
building a tire by causing a radial expansion of the central portion of the carcass ply until the carcass ply reaches a formation diameter; and
forming the tire, comprising laying, on a radially outer face of the carcass ply, at least one crown ply provided with parallel reinforcers forming a non-zero angle with a circumferential direction and a direction of the carcass reinforcers of the carcass ply, and laying a tread,
wherein, during the manufacture of the first tire and the manufacture of the second tire, the bead wires are fitted with a same bead wire separation distance, and
wherein, during the step of building the tire, when a radial expansion of the central portion of the carcass ply reaches an intervention diameter strictly less than a formation diameter, a triangulation member is placed in contact with the carcass ply in order to modify an orientation of the carcass reinforcers during a remainder of the step of building the tire, the triangulation member being provided with parallel triangulation reinforcers forming a non-zero angle with the circumferential direction and an initial direction of the carcass reinforcers of the carcass ply, the intervention diameter or the triangulation member or both the intervention diameter and the triangulation member being different during the manufacture of the first tire and during the manufacture of the second tire.

11. The method according to claim 10, wherein the intervention diameter is at least 10 mm less than the formation diameter.

12. The method according to claim 10, wherein the triangulation member has an axial width less than 80% of a final width of the tire.

13. The method according to claim 10, wherein the parallel reinforcers of the triangulation member form, prior to and while being placed in contact with the carcass ply, an angle of between 65° and 80° with the carcass reinforcers.

14. The method according to claim 10, wherein the triangulation member is a fabric impregnated with an elastomer compound.

15. The method according to claim 10, wherein the triangulation member is placed in contact with the carcass ply on an outer surface of the carcass ply.

16. The method according to claim 10, wherein the manufacture of the first tire makes use of a first triangulation member provided with parallel triangulation reinforcers forming a first non-zero angle with the circumferential direction and the initial direction of the carcass reinforcers, and the manufacture of the second tire makes use of a second triangulation member provided with parallel reinforcers forming a second non-zero angle with the circumferential direction and the initial direction of the carcass reinforcers, the second angle differing from the first angle by at least 5°.

17. The method according to claim 10, wherein the manufacture of the first tire makes use of a first triangulation member having a first axial width, and the manufacture of the second tire makes use of a second triangulation member having a second axial width, the second axial width differing from the first axial width by at least 10 mm.

18. The method according to claim 10, wherein, during the manufacture of the first tire, a triangulation member is placed in contact with the carcass ply of the first tire at a first intervention diameter, and during the manufacture of the second tire, a triangulation member is placed in contact with the carcass ply of the second tire at a second intervention diameter, the second intervention diameter differing from the first intervention diameter by at least 10 mm.

19. The method according to claim 10, wherein the intervention diameter is at least 20 mm less than the formation diameter.
